(19) United States
(12) Patent Application Publication
(10) Pub. No.: US 2010/0063832 A1
(43) Pub. Date: Mar. 11, 2010

(54) Incentive allocation based on thermostat settings

(76) Inventor: Stephen J. Brown, Woodside, CA (US)

Correspondence Address: LUMEN PATENT FIRM, 350 Cambridge Avenue, Suite 100, PALO ALTO, CA, 94306, US

(21) Appl. No.: 12/283,219

(22) Filed: Sep. 9, 2008

(51) Int. Cl. G06Q 10/00

(52) U.S. Cl. 705/1

(57) ABSTRACT

Incentive allocation to a community of users based on thermostat settings is provided. The users of the community establish user rules and thermostat settings directed to a climate-controlling device. The settings and rules are communicated to a central processor for calculating an incentive amount to allocate to each user. The calculated incentive amounts are based on the thermostat settings, energy consumption, and/or carbon emissions of the user. The incentives can also be calculated based on a comparison of a thermostat setting and a subsistence level. In an example, users of a multi-user development share a total amount of carbon credits given to the entire development. The carbon credits are distributed to each user based on the thermostat settings and carbon emission of each user.

### FIELD OF THE INVENTION

The invention relates generally to thermostats. More particularly, the present invention relates to network-connected thermostats and incentive allocation based on thermostat settings.

### BACKGROUND

Heating and cooling of residential and commercial buildings consumes an enormous amount of energy and is one of the greatest contributors to carbon dioxide emissions. In addition, heating and cooling can be problematic for energy suppliers, particularly during extreme weather conditions, as many consumers in a region require large amounts energy simultaneously, creating peak demand periods that can overwhelm the capacity of the energy suppliers. Certain energy resources, such as electricity, have limited energy storage capability; therefore balancing the energy load during peak demand periods is an important and difficult task.

High energy demands often force energy providers to use rolling blackouts to balance the load. In addition to stopping businesses and causing inconveniences, blackouts can cause public health problems, particularly for elderly consumers. Currently, energy providers rely on public or news announcements to encourage consumers to reduce energy consumption during peak demand periods. However, the public announcements are commonly ineffective, as the individual consumers do not have direct incentives to reduce consumption until the rolling blackouts occur.

To avoid rolling blackouts, energy providers can also purchase backup capacity from other sources, such as coal, oil, or natural gas-based electricity producers. However, these sources of additional energy are financially costly to the energy providers and the consumers. Furthermore, these additional energy sources produce a large amount of carbon dioxide and other greenhouse gases.

Heating and cooling systems typically include thermostats to allow users to set the desired temperatures. More advanced thermostats also provide other limited user controls, such as automatically turning off devices based on time of day or presence of people in a room. However, existing thermostats do not take into account factors such as user comfort, external conditions, and energy price and availability. Because of the limited user controls of existing thermostats, energy providers and managers are unable to influence the user behaviors to alleviate peak energy demands. In particular, energy price rates are typically set externally based on supply and demand, and not on individual consumer behavior. Existing energy pricing systems typically treat all consumption equally, without factoring the true costs of excess consumption. The resulting rising energy prices become a regressive tax on the poor while the truly profligate energy users pay the same rate for excess usage.

Recently, economic and environmental considerations have provided motivations for new economies to develop around carbon credits. Energy intensive industries, such as residential development, transportation, and manufacturing, plan to or have recently began to be involved with the economics of carbon credits. However, these industries fail to address the participants with the greatest ability to influence energy consumption: the consumers. This shortcoming is particularly evident with respect to residential power.

The present invention addresses at least the difficult problems of energy management and advances the art with a system for managing energy using smart thermostats.

### SUMMARY OF THE INVENTION

The present invention is able to overcome the shortcomings of existing systems and methods by enabling the consumer, as part of a multi-user community, to participate in the emerging carbon markets. In particular, the system of method of the present invention allows the consuming users to be rewarded for their contribution to reducing energy consumption, such as through carbon credits or financial incentives.

The present invention is directed to incentive allocation based on thermostat settings for a community of users, such as a building having multiple units, an apartment building, an office building, a retail development, a neighborhood, a housing development, an urban development, a suburban development, a district, a utility district, a city, a county, or any combination thereof. Each of the users of the community has a network-connected thermostat that directs a climate-controlling device. A setting function allows the users to adjust one or more settings on the thermostat and communicate the thermostat settings to a central processor. An amount of an incentive, such as a financial incentive or a carbon incentive, is calculated for each user based on the communicated thermostat settings. In an embodiment, a central processor calculates the incentive amounts. The calculated amounts are then allocated to the users.

In a preferred embodiment, a subsistence level is established for the community and the incentive amounts are calculated based on a comparison of the subsistence level with one of the thermostat settings of each user. The subsistence level can be based on received external data, including a weather condition, an energy price, or any combination thereof.

In an embodiment, an energy consumption and/or carbon emission is determined for each user. The energy consumption and carbon emission can be determined based on the thermostat settings and activity levels of the climate-controlling device. The calculation of the incentive amounts can be partially based on the carbon emission and/or energy consumption of each user.

In a preferred embodiment, a rules function is provided for allowing one of the users to establish one or more rules related to the thermostat settings, financial budgetary considerations, and/or carbon emission considerations. Thermostat settings of the user can be automatically adjusted based on the rules. The user-established rules provide users with incentives to reduce energy consumption, while maintaining their own individual preferences for comfort. Incentive allocation enables effective energy management by influencing user energy consumption behavior with incentive offers.

### BRIEF DESCRIPTION OF THE FIGURES

The present invention together with its objectives and advantages will be understood by reading the following description in conjunction with the drawings, in which:

FIG. 1 shows an example of a central processor CP allocating incentives to users based on thermostat settings of the users according to the present invention.

FIG. 2 shows an example system for allocating incentives based on thermostat settings from a smart thermostat and external data according to the present invention.

FIG. 3A shows an example continuous graph of energy price versus thermostat settings with respect to a subsistence level 340 according to the present invention.

FIG. 3B shows an example discrete graph of carbon credits versus thermostat settings with respect to a subsistence level 380 according to the present invention.

FIG. 4 shows an example of a smart thermostat with thermostat modules according to the present invention.

FIG. 5 shows an example of a smart thermostat that allows for user-inputted rules according to the present invention.

### DETAILED DESCRIPTION OF THE INVENTION

Energy resource management can be a difficult task. In particular, existing energy management schemes at the city utility level or in a multi-user community, typically lack methods for encouraging energy consumers to reduce or change their energy consumption. The present invention is directed to allocation of incentives to users based on energy consumption behavior, such as the thermostat settings, of the users.

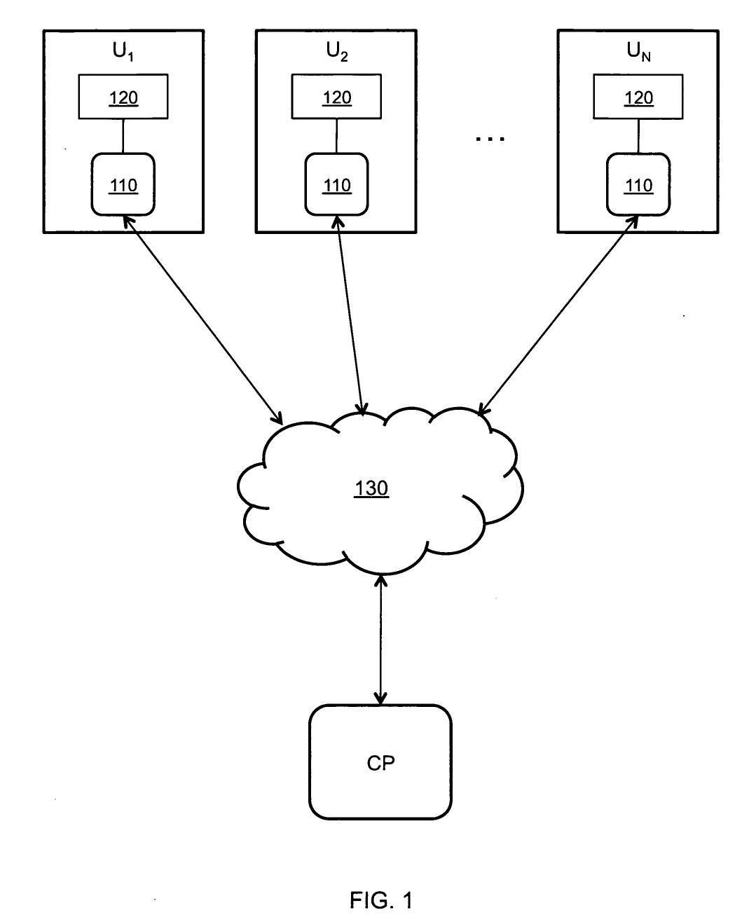

FIG. 1 shows a community of users U₁-U_{N} and a central processor CP connected to a network 130, such as the Internet. Each of the users of the community has a thermostat 110 that directs a climate-controlling device 120, such as a heating, venting, and air conditioning (HVAC) unit. In an embodiment, the climate-controlling device 120 of each user controls the temperature, or other climate condition, of all or part of a room or building. A setting function is provided for the users U₁-U_{N} to adjust settings on the thermostats 110. The thermostat settings are communicated to the central processor CP through the network 130. For each of the users, an incentive amount is calculated based at least in part on the communicated thermostat settings of the user. The incentives are then allocated to each user in amounts in accordance with the calculations.

The incentives allocated to the users can include any type of incentive that may be capable of motivating or encouraging the users to reduce or otherwise change their energy consumption. For example, the incentives can include carbon credits or financial incentives, such as a reduction or increase to energy price rates. In a preferred embodiment, the community is a multi-user development with users who are rewarded with a share of the total incentive for the entire community. The incentive is divided based on the individual behavior of the users, as indicated by their thermostat settings.

The community can include any number of users connected through any form of organization. For example, the community can include a multi-unit building, an apartment building, an office building, a retail development, a neighborhood, a housing development, an urban development, a suburban development, a district, a utility district, a city, a county, or any combination thereof.

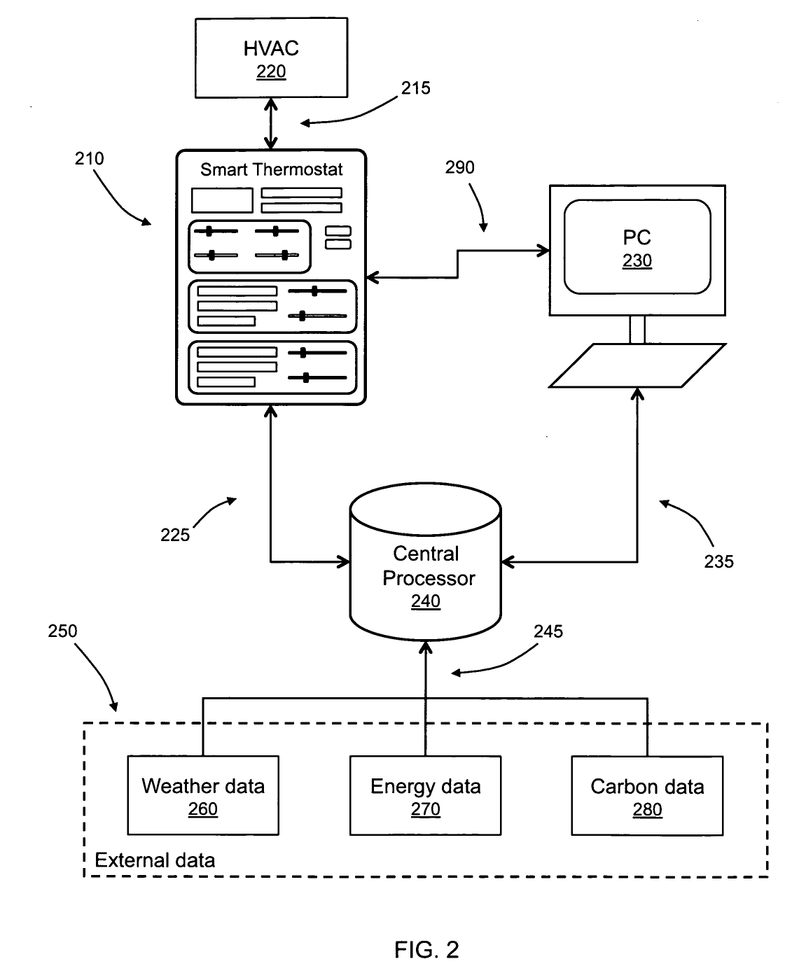

FIG. 2 shows a detailed view of the communicative connections for a user of the incentive allocating system according to the present invention. A smart thermostat 210 is operatively connected 215 to an HVAC unit 220 for controlling the activity of the HVAC unit 220. In an embodiment, thermostat settings on the smart thermostat 210 can be adjusted on a wall-mounted or otherwise-mounted device. Additionally or alternatively, users can adjust thermostat settings via a graphical user interface on a computing device, such as a personal computer 230, a mobile phone, or a personal digital assistant. The personal computer 230 can also be connected to a network to communicate 290 with the thermostat 210 or with the HVAC unit 220 directly. Similarly, the thermostat 210 is connected 225 with a central processor 240 for communicating thermostat settings to the central processor. In another embodiment, the thermostat settings can be communicated 235 to the central processor through network connections 290 to a personal computer 230.

It is important to note that the connections between any two or more of the thermostat 210, HVAC system 220, personal computer 230, and central processor 240 can be bidirectional. The central processor 240 calculates the incentive amount to provide to each user and allocates the calculated incentive amount to the users. Allocation can be through an energy bill, an electronic transfer of funds, an issuance of carbon credits, or any other means of allocating incentives.

In an embodiment, a user can adjust thermostat settings by use of a mobile phone, such as the iPhone by Apple Computers (Cupertino, Calif., USA). Text and/or voice messages can be used to communicate status or incentive changes to the user via a mobile phone in near real time. In certain embodiments, user decision input and response to the communicated messages can be sent to the central processor from the mobile phone. For example, an application for a mobile phone can be provided to allow users to adjust thermostat settings, including sensitivities to price and temperature. A portable device capable of communicating with a thermostat 210 would effectively be a remote controller for the smart thermostat 210.

As shown in FIG. 2, the central processor 240 can also receive 245 external data 250, such as weather data 260, energy data 270, carbon data 280, or any combination thereof. The weather data 260 can include current and projected weather conditions. Types of energy data 270 include current and projected energy prices, energy availability, and other information provided by energy suppliers. Carbon data 280 can include data pertaining to carbon emission standards and/or carbon credit allocation.

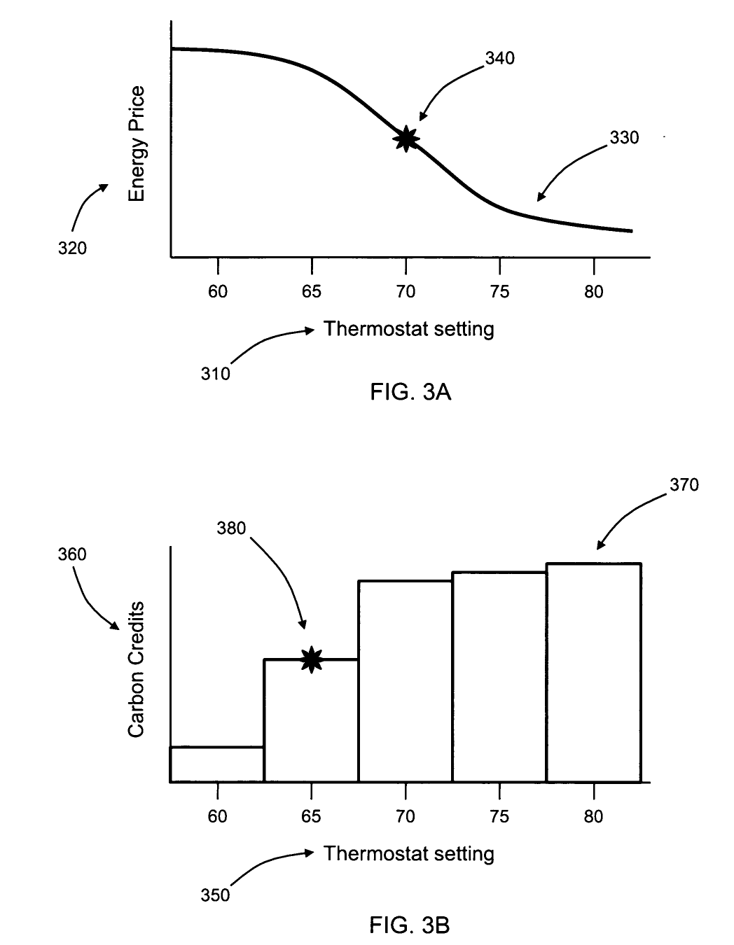

In a preferred embodiment, a subsistence level is established for the community and the calculated incentive amount for each user is based on a comparison of the subsistence level with a thermostat setting of the same user. The subsistence level can be established based on the external data. FIG. 3A shows an example plot of energy price rate 320 versus thermostat setting 310 in a warm environment where cooling by an air conditioner is generally desired. The subsistence level 340 indicates a comfortable temperature of 70 degrees based on the outside weather conditions and the power availability. In the example shown in FIG. 3A, the incentive amount is represented by the continuous line graph 330, where the energy price rate 320 depends on the thermostat temperature setting 310. In particular, the energy price rate 320 is high when the thermostat setting 310 is below the subsistence level 340 and low when it is above the subsistence level 340.

FIG. 3B shows an example discrete chart 370 of incentives versus thermostat setting 350. In the example, the incentive is a number of carbon credits 360 or share of a total amount of carbon credits. Similar to the plot in FIG. 3A, a subsistence level 380 is established for a warm environment where a cooling device is desirable. Larger amounts of carbon credits are allocated for higher thermostat settings 350 with respect to the subsistence level 380.

By allocating incentives based on thermostat settings with respect to a subsistence level, individual user lifestyle choices can be rewarded or penalized. In other words, users are given an opportunity to change their behavior and receive incentives for doing so. For example, a user is rewarded for wearing a sweater instead of increasing heating, thereby reducing energy consumption. Utility managers benefit by having the capability of affecting user power demand by offering variable amounts of incentives, thereby alleviating peak power demands. It is important to note that the subsistence levels can be dynamically changed over time based on the external data. The shape of the incentive versus thermostat curves used in calculating incentive amounts can also be dynamically changed.

In a preferred embodiment, the subsistence level is the lowest heating level (in a cold climate) or the highest cooling level (in a warm climate) for the thermostat setting of a user that does not incur any penalties. For example, the subsistence level establishes thermostat settings in which energy is offered at a minimum rate. Penalty rates are charged for users that consume energy to reach temperatures at luxury levels. The subsistence level allows for a non-regressive consumer-end energy system. In contrast, for a system with energy pricing that simply escalates with demand and lacks a subsistence level, poorer users will not be able to afford much necessary heating and cooling while richer users will simply pay a premium energy rate. In other words, embodiments of the present invention provides a “Pay for Performance” HVAC system.

In a preferred embodiment, the calculated incentive amount for each user is at least partially based on an energy consumption of the user and a thermostat setting, such as the current temperature, of the user. For example, the incentive can be a variable energy price that depends on the energy consumption of the users and the thermostat settings. The energy consumption can be determined by an activity level of the climate-controlling device and/or stored information relating to the climate-controlling device, such as the make and model of the climate-controlling device. In an embodiment, the smart thermostat communicates an activity level of the climate-controlling device to the central processor. The thermostat can measure the difference in overall or average power usage when the climate-controlling device is on versus off to determine energy consumption. In one embodiment, a utility may require the climate-controlling device to include a power consumption sensor and charge a penalty rate when no signal from the sensor of the climate-controlling device is transmitted.

In another embodiment, the calculated incentive amount for each user can be partially based on the carbon emission of the user. Similar to the energy consumption of a user, the user's carbon emission can be determined by one or more thermostat settings of the user, an activity level of the climate-controlling device, and/or stored information relating to the climate-controlling device of the user.

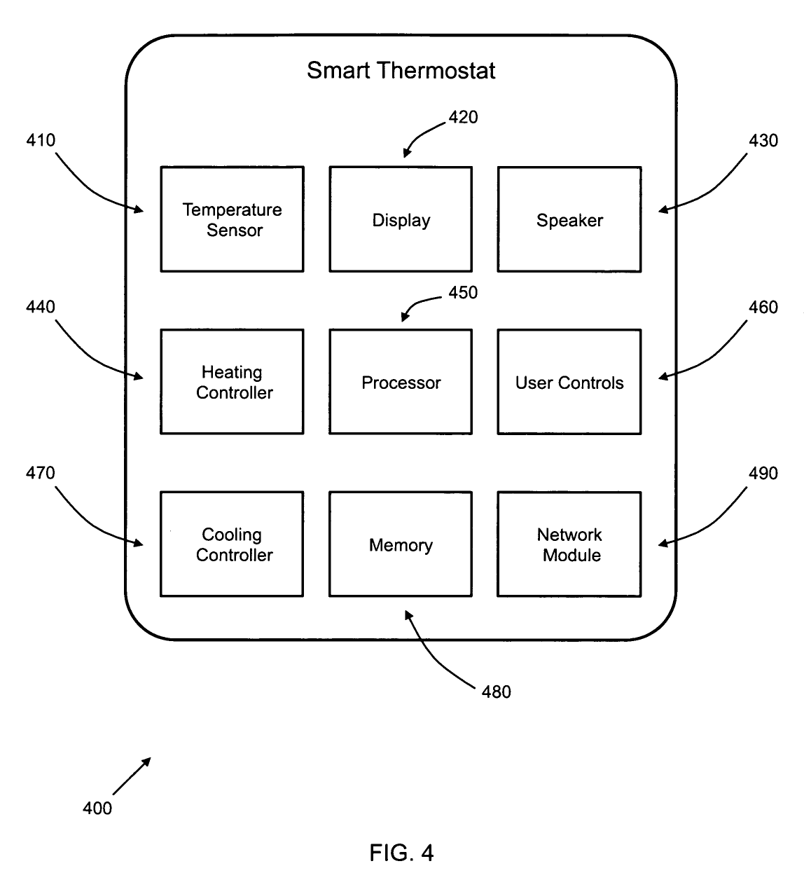

FIG. 4 shows an example smart thermostat 400, including thermostat modules, according to the present invention. The smart thermostat 400 includes a temperature sensor 410 for measuring the temperature of the room or building. The heating 440 and cooling 470 controllers transmit signals to the heater and air conditioner, respectively, to control the activity of one or more climate-controlling devices, such as variable heating and cooling levels and rates of heating and cooling. The heating 440 and cooling 470 controllers can transmit signals based on the temperature measured by the temperature sensor 410 and by more sophisticated user rules to be described below.

The user control 460 allows the user to adjust and set desired heating and/or cooling temperatures, temperature ranges, or user rules. The user control 460 can include a graphical user interface (GUI) for a computing device, a button, a knob, sliders, or a touch screen. User controls can be processed by the processor 450, which directs the heating 440 and cooling 470 controllers. User-inputted settings and external data can be stored in memory 480, which is accessible by the processor 450. User settings and/or external data can be shown on a display 420, such as a liquid crystal display.

It is important to note that the smart thermostat 400 includes a network module for connecting the smart thermostat 400 with the central processor. The network connection can be through a cell phone network, a WIFI or other wireless network, a telephone line, a cable network, an Internet connection, a power line, or any other connection mechanism capable of transmitting and receiving data. In an embodiment, the network module 490 allows for connections between the smart thermostat 400 and a computing device, such as a personal computer, a personal digital assistant, or a laptop computer. Network connections allow the processor 450 to receive external data and process the heating and cooling controls based on the external data. Network connections also allow the smart thermostat 400 to transmit thermostat settings to the central processor.

In an embodiment, the smart thermostat also includes a speaker 430 or another audio-visual mechanism to alert users of any relevant changes, such as calculated incentives, subsistence levels, external data, or thresholds from user rules. The alerts may occur while the user is inputting desired settings and/or after the central processor has communicated changes to the smart thermostat 400.

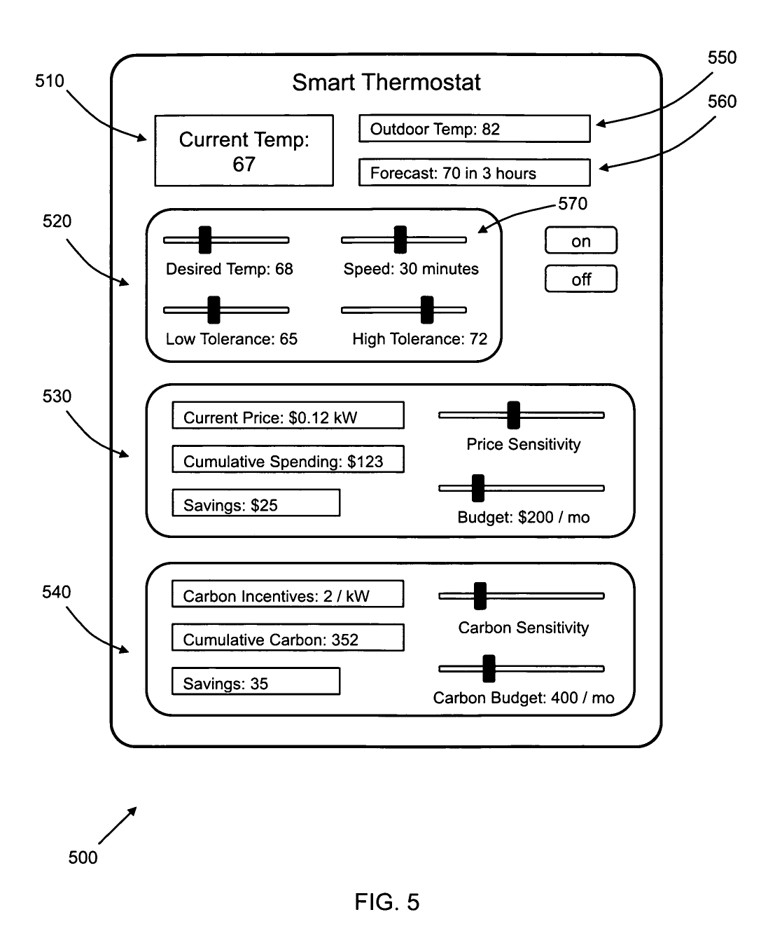

FIG. 5 shows an exemplary embodiment of a smart thermostat 500. The smart thermostat 500 includes a display of the current temperature in the room 510, the desired temperature settings 520, rules relating to pricing data 530, rules relating to carbon emissions 540, and external data 550-560, such as current 550 and projected 560 outdoor temperatures. The desired temperature settings can include user rules relating to temperature tolerances and desired rates of heating/cooling 570.

In a preferred embodiment, a rules function is provided to allow a user to establish user rules related to a financial budget of the user. The financial user rules can be associated with current energy prices or rates as communicated to the smart thermostat 500 by the central processor. Similarly, in an embodiment, the rules function is provided to allow a user to establish user rules related to a carbon budget. The carbon incentives and current prices can be communicated to the smart thermostat 500 by the central processor and the rules can depend on the incentives, price, or any combination thereof. In an embodiment, the processor automatically adjusts the thermostat settings based on the rules and communicated incentive data. In certain embodiments, users can enter one or more user rules directly on the thermostat.

In an embodiment, the user inputs allowed by the rules function include sensitivity to price and/or carbon emissions, where the sensitivity is used to weight the external price and/or carbon in calculating the monthly financial and carbon budgets, respectively. The financial savings, cumulative spending, carbon savings, and carbon emissions can be calculated by the smart thermostat 500 or can be communicated to the thermostat 500 by the central processor. Carbon savings can include financial savings or savings in terms of carbon credits.

Below are examples of three users and their user-inputted thermostat settings with different sensitivities to a price incentive. In the examples, all three users belong to the same community and experience warm weather where air conditioning is desired.

User 1 is least sensitive to cost and has a desired temperature setting of 70 degrees regardless of cost. The subsistence level is 74 degrees at a base rate of $X per kWh, and an excess rate of $2X per kWh for any temperature setting lower than 74 degrees. While the internal temperature is above 74 degrees and the air conditioner is running, user 1 is charged $X per kWh for energy used. When the internal temperature reaches 74 degrees and the air conditioner is still active, the user is charged $2X per kWh of energy consumed. When the internal temperature is at or below 70 degrees, the thermostat shuts off the air conditioner, and user 1 does not incur additional energy costs due to the air conditioner.

User 2 is moderately sensitive to cost and has a desired temperature setting of 72 with an audio notification when the subsistence level changes or pricing levels reaches a certain threshold. When the audio notification is active, user 2 can elect to change the desired temperature setting or keep the current settings.

User 3 is highly sensitive to cost and has a desired temperature setting of 74. User 3 also establishes rules that if subsistence level changes to automatically change the thermostat setting to the current subsistence level. Therefore, whenever the air conditioner of user 3 is active, user 3 will only be charged the base rate.

As one of ordinary skill in the art will appreciate, various changes, substitutions, and alterations could be made or otherwise implemented without departing from the principles of the present invention, e.g. other communication networks, such as a LAN or a WAN, can be used in addition to or in replacement of the Internet and other incentives, such as discount offers, can be used. Accordingly, the scope of the invention should be determined by the following claims and their legal equivalents.

What is claimed is:

1. A method for allocating incentives in a community of a plurality of users based on thermostat settings of said users, said method comprising:
(a) receiving one or more thermostat settings from each of said users of said community, wherein said thermostat settings are related to one or more conditions for operating a climate controlling device of each of said users, wherein said thermostat settings are adjustable by the same of said users, and wherein said thermostats are communicatively connected to a communication network;
(b) calculating an incentive amount for allocation to one or more of said users, wherein said incentive amount is at least partially based on said communicated thermostat settings; and
(c) allocating said calculated amount of said incentive to one or more of said users based on said calculations.

2. The method as set forth in claim 1, wherein said incentive comprises a carbon credit, a financial incentive, or any combination thereof.

3. The method as set forth in claim 1, further comprising establishing a subsistence level for said community, wherein said calculating of said incentive amount for each of said users is at least partially based on a comparison of said subsistence level with at least one of said thermostat settings of the same of said users.

4. The method as set forth in claim 3, further comprising receiving one or more external data, wherein said subsistence level is established at least partially based on said received external data, and wherein said external data comprises a weather condition, an energy price, or any combination thereof.

5. The method as set forth in claim 1, further comprising determining a carbon emission for each of said users, wherein said carbon emission of each of said users is at least partially based on one or more of said thermostat settings of the same of said users, and wherein said calculating of said incentive amount for each of said users is at least partially based on said carbon emission of the same of said users.

6. The method as set forth in claim 1, further comprising determining an energy consumption of each of said users, wherein said thermostat of each of said users displays a current temperature experienced by the same of said users, and wherein said calculated incentive amount for each of said users is at least partially based on said determined energy consumption and said current temperature of the same of said users.

7. The method as set forth in claim 6, wherein said incentive comprises a variable energy price, and wherein said variable energy price for each of said users is at least partially based on said energy consumption and said current temperature of the same of said users.

8. The method as set forth in claim 6, further comprising receiving an activity level of said climate-controlling device of each of said users, wherein said energy consumption of each of said users is determined at least partially based on:
(i) said activity level of said climate-controlling device;
(ii) stored information relating to said climate-controlling device; or
(iii) said activity level of said climate-controlling device and said stored information relating to said climate-controlling device.

9. The method as set forth in claim 1, further comprising receiving one or more rules established by one of said users of said community, wherein said rules are related to said thermostat settings of the same of said users, and wherein one or more of said thermostat settings of the same of said users is automatically adjusted based on said rules.

10. The method as set forth in claim 9, wherein one of said rules is related to a budget of said user establishing the same of said rules, and wherein said budget can be a financial budget, an energy budget, a carbon budget, or any combination thereof.

11. A system for allocating incentives, said system comprising:
(a) a community of a plurality of users, wherein each of said users has a climate-controlling device;
(b) a thermostat for each of said users of said community, wherein said thermostat directs said climate-controlling device of the same of said users, and wherein each of said thermostats are communicatively connected to a communication network;
(c) a setting function for allowing each of said users of said community to adjust one or more settings on said thermostat, wherein said thermostat settings are related to one or more conditions for operating said climate-controlling device;
(d) a central processor communicatively connected to said communication network, wherein said thermostat settings of each of said users are communicated to said central processor through said communication network, wherein said central processor calculates an incentive amount for allocation to one or more of said users, and wherein said incentive amount is at least partially based on said communicated thermostat settings; and
(e) an allocation function for allocating said calculated amount of said incentive to one or more of said users based on said calculations.

12. The system as set forth in claim 11, wherein said incentive comprises a carbon credit, a financial incentive, or any combination thereof.

13. The system as set forth in claim 11, wherein said central processor establishes a subsistence level for said community, and wherein said calculated incentive amount for each of said users is at least partially based on a comparison of said subsistence level with at least one of said thermostat settings of the same of said users.

14. The system as set forth in claim 13, further comprising a data retrieval function for receiving one or more external data, wherein said subsistence level is established at least partially based on said received external data, and wherein said external data comprises a weather condition, an energy price, or any combination thereof.

15. The system as set forth in claim 11, wherein said central processor determines a carbon emission for each of said users, wherein said carbon emission of each of said users is at least partially based on one or more of said thermostat settings of the same of said users, and wherein said calculating of said incentive amount for each of said users is at least partially based on said carbon emission of the same of said users.

16. The system as set forth in claim 11, wherein said central processor determines an energy consumption of each of said users, wherein said energy consumption of each of said users is determined at least partially based on an activity level of said climate-controlling device of the same of said users, wherein said thermostat communicates a current temperature and said activity level of said climate-controlling device of each of said users to said central processor, and wherein said calculated incentive amount for each of said users is at least partially based on said determined energy consumption and said current temperature of the same of said users.

17. The system as set forth in claim 11, further comprising a rules function for allowing one of said users of said community to establish one or more rules related to said thermostat settings, wherein one or more of said thermostat settings of the same of said users is automatically adjusted based on said rules.

18. The system as set forth in claim 17, wherein one of said rules is related to a budget of said user establishing the same of said rules, wherein said budget can be a financial budget, an energy budget, a carbon budget, or any combination thereof.

19. The system as set forth in claim 11, further comprising a portable device operated by one of said users, wherein said portable device is communicatively connected to said central processor, and wherein said one or more thermostat settings of the same of said users are adjusted on said portable device.

20. The system as set forth in claim 11, wherein said community comprises a building having multiple units, an apartment building, an office building, a retail development, a neighborhood, a housing development, an urban development, a suburban development, a district, a utility district, a city, a county, or any combination thereof.
